(19) United States
(12) Patent Application Publication
(10) Pub. No.: US 2026/0358533 A1
(43) Pub. Date: Nov. 12, 2026

(54) LENS ARRAY

(71) Applicant: Nippon Sheet Glass Company, Limited, Tokyo (JP)

(72) Inventors: Hiroaki KATO, Kanagawa (JP); Mizuho KOYO, Hyogo (JP); Kazuto MORIYAMA, Kanagawa (JP); Kazuishi MITANI, Osaka (JP)

(21) Appl. No.: 19/125,649

(22) PCT Filed: Oct. 27, 2023
(86) PCT No.: PCT/JP2023/038981

§ 371 Date: Apr. 29, 2025

(30) Foreign Application Priority Data
Oct. 31, 2022 (JP) 2022-174058

(51) Int. Cl. G02B 3/00; C03C 3/089; C03C 17/00; C08K 3/22; C08K 3/36; C09D 5/00; C09D 7/40; C09D 7/61; C09D 183/04

(52) U.S. Cl. CPC G02B 3/0075; C03C 3/089; C03C 17/00; C09D 5/006; C09D 7/61; C09D 7/67; C09D 7/68; C09D 183/04; G02B 3/0087; C08K 2003/2227; C08K 3/36; C08K 2201/005; C08K 2201/011

(57) ABSTRACT

A lens array 1a includes a plurality of lenses 11, an adhesive portion 12, a housing 15, and an antireflection film 20. The lens array 1a is used for an apparatus for defect inspection by use of reflected light from an inspection object being conveyed. The lenses 11 are arrayed in a first direction (y-axis direction) that is a conveyance direction in which the inspection object is conveyed and in a second direction (x-axis direction) that is perpendicular to the conveyance direction. The lenses 11 focus the reflected light from the inspection object being conveyed. The adhesive portion 12 fixes the lenses 11 together. The housing 15 contains the lenses 11 and the adhesive portion 12. The antireflection film 20 includes fine particles 21 and a binder 22. The antireflection film 20 is in contact with at least one selected from the group consisting of a first plane 11a of each of the lenses 11 on which the reflected light is to be incident and a second plane 11b of each of the lenses 11 from which the light incident on the first plane 11a is to be emitted.

### TECHNICAL FIELD

The present invention relates to a lens array.

### BACKGROUND ART

Lens arrays have conventionally been used for image reading.

For example, Patent Literature 1 describes a stacked lens array unit for a compound-eye optical system. The stacked lens array unit includes a first lens array, a second lens array, and a positioning portion. The first lens array and the second lens array each has a rectangular outline when viewed from an optical axis direction, and has a plurality of lens elements arrayed in two dimensions. The first lens array and the second lens array are stacked in the optical axis direction. The positioning portion is provided in the surrounding region that surrounds the lens elements along an edge of the first lens array and an edge of the second lens array. The positioning portion has a first contact portion disposed closer to the first lens array and a second contact portion disposed closer to the second lens array and facing the first contact portion, and the positioning portion has a predetermined tapered surface. Thereby, it is possible to impose restrictions on the planar direction and a rotational direction about an axis perpendicular to the plane without applying stress to the lens array, where such restrictions are necessary for the lens array. Therefore, assembly can be carried out with high precision while maintaining high optical performance. In addition, since the structure between neighboring lens elements of the lens array can be made simple, it is possible to perform molding with high precision, and it is easy to secure a wide effective area for the lens elements.

### CITATION LIST

### Patent Literature

Patent Literature 1: WO 2014/192933

### SUMMARY OF INVENTION

### Technical Problem

In an apparatus for defect inspection by use of reflected light from an inspection object being conveyed, it is not envisaged that the lens array unit described in Patent Literature 1 will be used. In the case of using a lens array in such an apparatus, for certain inspection objects, a lens array compatible with various measurement wavelengths may be regarded as advantageous.

The present invention provides a lens array that is advantageous from the viewpoint of the range of measurement wavelengths that can be inspected with an apparatus for defect inspection by use of reflected light from the inspection object being conveyed.

### Solution to Problem

The present invention provides a lens array to be used for an apparatus for defect inspection by use of reflected light from an inspection object being conveyed, the lens array including:
a plurality of lenses for focusing the reflected light, the lenses being arrayed in a first direction that is a conveyance direction in which the inspection object is conveyed and a second direction perpendicular to the conveyance direction;
an adhesive portion for fixing the lenses together;
a housing containing the lenses and the adhesive portion; and
an antireflection film, wherein the antireflection film includes fine particles and a binder, the fine particles having a refractive index equal to or less than a refractive index of the lenses, and the antireflection film is disposed in contact with at least one selected from the group consisting of a first plane of each of the lenses on which the reflected light is to be incident and a second plane of the lens from which the light incident on the first plane is to be emitted, and
the binder binds the fine particles to either the first plane or the second plane.

### Advantageous Effects of Invention

The lens array is advantageous from the viewpoint of the range of measurement wavelengths that can be inspected with an apparatus for defect inspection by use of reflected light from the inspection object being conveyed.

### BRIEF DESCRIPTION OF DRAWINGS

FIG. 1 is a schematic perspective view showing an example of a lens array according to the present invention.

FIG. 2 is a graph showing a refractive index distribution of a lens.

FIG. 3 is a side view showing an example of each of the lenses shown in FIG. 1.

FIG. 4 is a cross-sectional view of an example of an inspection apparatus including the lens array shown in FIG. 1.

FIG. 5A is a FE-SEM photograph showing a cross-section of an antireflection film of a lens array according to Example 1.

FIG. 5B is a FE-SEM photograph showing a cross-section of an antireflection film of a lens array according to Example 6.

FIG. 5C is a FE-SEM photograph showing a cross-section of an antireflection film of a lens array according to Example 7.

FIG. 6 is a cross-sectional view schematically showing a cross-section of an antireflection film of a lens array according to Example 8.

### DESCRIPTION OF EMBODIMENTS

Embodiments of the present invention will be described below with reference to the accompanying drawings. The following description is for illustrating an example of the present invention, and the present invention is not limited to the embodiments described below.

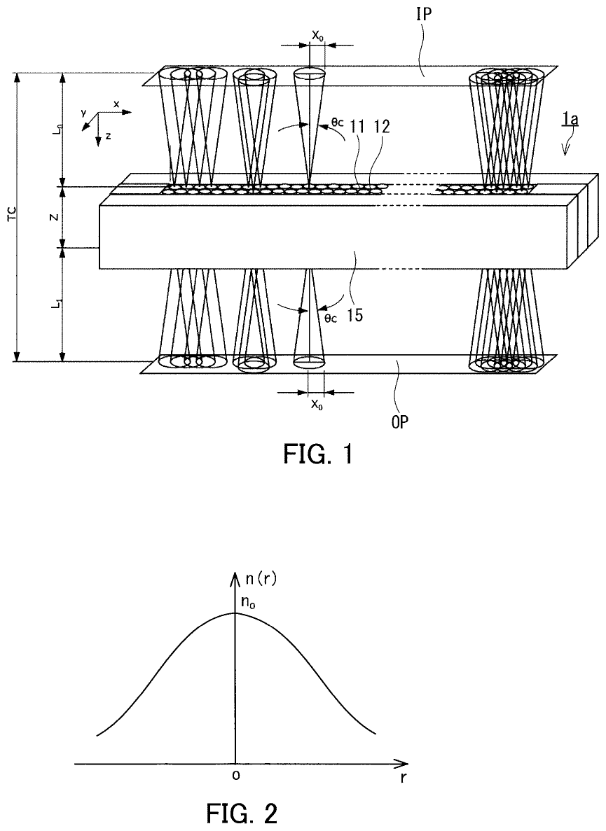

As shown in FIG. 1, a lens array 1a includes a plurality of lenses 11, an adhesive portion 12, and a housing 15. The lens array 1a is used for an apparatus for defect inspection by use of reflected light from an inspection object being conveyed. The lenses 11 are arrayed in a first direction (y-axis direction) that is a conveyance direction in which the inspection object is conveyed and in a second direction (x-axis direction) that is perpendicular to the conveyance direction. The lenses 11 focus the reflected light from the inspection object being conveyed. The adhesive portion 12 fixes the lenses 11 together. The housing 15 contains the lenses 11 and the adhesive portion 12. The lenses 11 have a working distance L₁ of 5 mm or more, for example.

The lens array is often used for applications such as image reading. In this case, it is advantageous that the working distance of the lens array is small for the purpose of miniaturization of the apparatus with the lens array, because the distance between the object to be read and the lens array can be decreased. On the other hand, in the case where the lens array is used for an apparatus for defect inspection by use of reflected light from an inspection object being conveyed, foreign matters or the like derived from the inspection object being conveyed is likely to adhere to the surface of the lens array. For this reason, such an apparatus may require regular or irregular maintenance. In this case, if the distance between the lens array and the inspection object is small, it is difficult to secure a sufficient space for the maintenance of the apparatus. As for the lens array 1a, a lens 11 has the working distance of 5 mm or more. Therefore, when the lens array 1a is used for an apparatus for defect inspection by use of reflected light from the inspection object being conveyed, the distance between the lens array 1a and the inspection object is likely to be large, and a sufficient space for maintenance of the apparatus can be easily secured.

The working distance L₁ of the lens 11 is preferably 8 mm or more, more preferably 10 mm or more, even more preferably 15 mm or more, and particularly preferably 20 mm or more, and in particular preferably 25 mm or more. The working distance L₁ is, for example, 60 mm or less, it may be 55 mm or less, or may be 50 mm or less.

The lens 11 is, for example, a gradient index lens. In FIG. 1, OP is an object plane and IP is an image plane. TC is a conjugation length, Z is a lens length, X₀ is a visual field radius, and θc is an aperture angle.

In FIG. 1, L₀ is a distance between the image plane IP and the lens 11 at the time the value of a modulation transfer function (MTF) becomes maximum. In FIG. 1, the lens array 1a, for example, constitutes a substantial erecting equal-magnification image system, and the working distance L₁ is approximately equal to the distance L₀.

In the lens 11, the conjugation length TC is, for example, 35 mm to 160 mm, preferably 40 mm to 150 mm, and more preferably 48 mm to 100 mm. In the lens 11, the relationship TC=L₁+Z+L₀ holds.

In the lens 11, the aperture angle θc is, for example, 3° to 22°, and preferably 4° to 12°.

The lens 11 is, for example, a rod lens, and the central axis of the lens 11 extends in the optical axis direction of the lens 11. As shown in FIG. 2, the lens 11 has a refractive index distribution in its radial direction. In FIG. 2, no is a refractive index at the central axis line of the lens 11, and r is a distance [mm] from the central axis line of the lens 11 in the radial direction of the lens 11. The refractive index n (r) of the lens 11 at the distance r is expressed by the following Formula (1). In Formula (1), g is a refractive index distribution constant [mm⁻¹] of the lens 11.

n(r)²=n₀²{1−(g·r)²} Formula (1)

The refractive index distribution constant of the lens 11 is, for example, 0.06 mm⁻¹ to 0.48 mm-1, and preferably 0.08 mm⁻¹ to 0.26 mm⁻¹.

The lens 11 may be made of a resin or glass. In the case where the lens 11 is made of a resin, the resin used to make the lens 11 may include, for example, a translucent resin such as an acrylic resin, a polycarbonate resin, a polyolefin resin, or a silicone resin. In the case where the lens 11 is made of glass, the center of the lens 11 has, for example, a composition as described below. If the center of lens 11 has this composition, the working distance L₁ is likely to be large, and the working distance L₁ is likely to be the desired value. The center of the lens 11 is, for example, a portion that composes the optical axis of the lens 11. The composition is expressed as follows by mol %:
40%≤SiO₂≤65%;
0%≤TiO₂≤10%;
0.1%≤MgO≤22%;
0.15%≤ZnO≤15%;
0.5%≤Li₂O≤15%;
2%≤Na₂O≤20%;
0%≤B₂O₃≤20%;
0%≤Al₂O₃≤10%;
0%≤K₂O≤3%;
0%≤Cs₂O≤3%;
0%≤Y₂O₃≤5%;
0%≤ZrO₂≤2%;
0%≤Nb₂O₅≤5%;
0%≤In₂O₃≤5%;
0%≤La₂O₃≤5%; and
0%≤Ta₂O₅≤5%.

In the case where the lens 11 is made of glass, the lens 11 can be manufactured, for example, by a method including the following steps (I) and (II).
(I) A glass strand having the aforementioned composition is produced.
(II) The glass strand is immersed in a molten salt containing a second alkali metal element R that is different from the first alkali metal element Q contained in the aforementioned composition, so that the first alkali metal element Q in the glass strand and the second alkali metal element R in the molten salt are subjected to an ion exchange treatment, thereby forming a refractive index distribution in the glass strand.

In the step (II), for example, the glass strand is introduced into the molten salt inside a container and the glass strand is immersed in the molten salt for a predetermined time. In the molten salt, for example, at least either potassium nitrate or sodium nitrate is melted. When the glass strand is immersed in the molten salt, for example, a cation such as Li (lithium) of the first alkali metal element Q contained in the glass strand dissolves into the molten salt. In the meantime, a cation of the second alkali metal element R in the molten salt such as sodium (Na) penetrates into the glass strand. By adjusting the temperature of the molten salt and the time for immersing the glass strand in the molten salt, the ion exchange between the cation of the first alkali metal element Q and the cation of the second alkali metal element R can be appropriately controlled. A concentration distribution of a specific monovalent cation is generated inside the glass strand, and a lens 11 having a refractive index distribution as shown in FIG. 2 is obtained in accordance with the concentration distribution. Since such an ion exchange hardly occurs in the center of the glass strand, the center of the lens 11 has the initial composition of the glass strand. Therefore, the center of the lens 11 has the aforementioned composition.

As shown in FIG. 1, the lenses 11 form a plurality of rows adjacent in the second direction (x-axis direction), for example. With this configuration, even in the case where the visual field radius X₀ is small, the reflected light from the inspection object is easily focused over the entire second direction of the arrays of the lenses 11. As a result, precision of the inspection for a defect in the inspection object is likely to be improved. The number of rows formed in the second direction of the lenses 11 may be two, or may be more than or equal to three. In the rows of the lenses 11 formed in the second direction, the rows of the lenses 11 neighboring each other in the first direction are formed so that the central axis lines of the lenses 11 are offset, for example, in the second direction.

The adhesive portion 12 fills gaps between the lenses 11, thereby combining the lenses 11. The adhesive portion 12 contains a resin and is colored black, for example.

The housing 15 is not limited to a specific configuration, as long as it can contain the lenses 11 and the adhesive portion 12. The housing 15, for example, includes a pair of plates aligned in a first direction and a pair of plates aligned in a second direction, and is provided as a frame formed of these plates. These plates, for example, include a fiber-reinforced plastic (FRP).

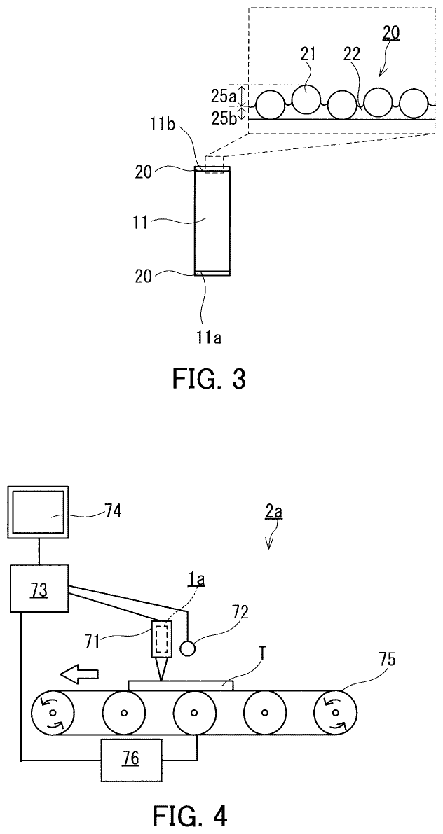

As shown in FIG. 3, the lens array 1a further includes, for example, an antireflection film 20. The antireflection film 20 is disposed, for example, in contact with at least one selected from the group consisting of a first plane 11a and a second plane 11b. The first plane 11a is a plane of each of the lenses 11 on which reflected light from an inspection object being conveyed is to be incident. The second plane 11b is a plane from which the light incident on the first plane 11a of the lens 11 is to be emitted.

As described above, since the lens 11 has a working distance L₁ of 5 mm or more, an image obtained by means of the lens 11 is unlikely to be bright, and the intensity of light entering the image sensing device such as the charge-coupled device (CCD) used to inspect for a defect in the inspection object in the above-described apparatus is likely to be lowered. For example, in the case where a lens with a working distance L₁ that is 1.5 times longer is used, the brightness may decrease by about 30%, though it depends on the working distance L₁ of the lens or the aperture angle. In this case, for example, it is possible to increase the brightness of the light source to generate reflected light from the inspection object. However, if the light source is brighter, the running cost of the apparatus tends to be increased. Another concern is that the inspection object may be affected by the increase in amount of heat generation by the light source. Meanwhile, if the lens array 1a includes an antireflection film 20, re-reflection of the reflected light from the inspection object is suppressed at the first plane 11a and second plane 11b of the lens 11. As a result, even without increasing the brightness of the light source, a bright image may be easily obtained using the lens 11, and intensity the light incident on the image sensing device is unlikely to decrease.

The antireflection film 20 may be disposed in contact with only the first plane 11a, only the second plane 11b, or both the first plane 11a and the second plane 11b.

The antireflection film 20 is not limited to a specific configuration, as long as it can increase intensity of the light to be emitted from the second plane 11b compared to a case where the antireflection film 20 is not formed.

The antireflection film 20, for example, includes fine particles 21 and a binder 22, as shown in FIG. 3. The fine particles 21 have, for example, a refractive index equal to or lower than the refractive index of the lens 11. In this case, the refractive index of the lens 11 is the maximum refractive index of the lens 11, for example, the refractive index at the center of the lens 11. The binder 22 binds the fine particles 21 to the first plane 11a or to the second plane 11b. With this configuration, the antireflection film 20 is likely to exhibit the desired antireflective properties over a wide wavelength range. As a result, the lens array 1a is likely to correspond to various measurement wavelengths. For example, in addition to the case where the measurement wavelength is within the visible light region, the desired antireflective properties are also likely to be exhibited in the case where the measurement wavelength is within the near-infrared region, and intensity of the light to be emitted from the second plane 11b can be increased. The antireflection film 20 is likely to exhibit the desired antireflective properties even if it is formed to have a relatively simple structure such as a monolayer structure. In addition, processes such as a vacuum process or a treatment at high temperature are not required, whereby influences of such processes or treatments on the lens 11 can be prevented, and the cost for manufacturing the lens array 1a can be reduced.

Methods for forming an antireflection film on a lens may be a method for forming an optical interference film that is a dielectric multilayer film by a method such as vacuum deposition, sputtering, or chemical vapor deposition (CVD). However, in this case, the reflectance will increase rapidly outside the wavelength range designed for antireflection, and this may impose a limit to the extent to which the antireflective effect can be exhibited over a wide wavelength range. In addition, this method requires a process such as a vacuum process or heating at high temperatures, and there is a possibility, for example, that the resin contained in the lens array 1a will foam during the vacuum process. For this reason, it may be unpractical to form a dielectric optical interference film as an antireflection film on the lens 11.

For example, the surface layer of the antireflection film 20 has irregularities formed by the fine particles 21. As a result, a low-refractive-index portion 25a with a refractive index lower than the refractive index of the lens 11 is formed. With this configuration, the antireflection film 20 is more likely to exhibit the desired antireflective properties over a wide wavelength range.

As shown in FIG. 3, for example, the antireflection film 20 includes a base portion 25b between the low-refractive-index portion 25a and the lens 11 in the thickness direction of the antireflection film 20. The binder 22 forms a layer between the fine particles 21 at the base portion 25b. The low-refractive-index portion 25a is a portion of the antireflection film 20 other than the base portion 25b. The content of the binder 22 at the base portion 25b is higher than the content of the binder 22 at the low-refractive-index portion 25a, based on the mass. Thereby, the antireflection film 20 is likely to exhibit its desired antireflective performance, and the antireflection film 20 is unlikely to peel off the lens 11. In the maintenance of the above-mentioned apparatus, there is a possibility that the antireflection film 20 comes into contact with other objects. However, since the content of the binder 22 at the base portion 25 is higher than the content of the binder 22 at the low-refractive-index portion 25a, the bonding strength of the antireflection film 20 to the lens 11 is likely to be enhanced.

The antireflection film 20 contains silicon atoms for example, and a bond involving a silicon atom, such as a Si—O—Si bond, is formed between the antireflection film 20 and the lens 11. With this configuration, the bonding strength of the antireflection film 20 to the lens 11 is more likely to be enhanced. In the case where the lens 11 is made of glass, a silanol group may be present on the surface of the lens 11. Therefore, a bond involving a silicon atom such as a Si—O—Si bond may be formed by a condensation reaction between the silanol group on the surface of the lens 11 and the silanol group contained in the antireflection film 20. In the case where the lens 11 is made of a resin, the surface of the lens 11 may be subjected to a primer treatment. This may form a bond involving a silicon atom, such as a Si—O—Si bond, between the lens 11 and the antireflection film 20.

The component contained in the fine particles 21 is not limited to a specific component. The fine particles 21 contain silica, for example, as a main component. In the present Description, the main component is the component that is most abundant by mass. A bond involving a silicon atom, such as a Si—O—Si bond, is formed between the fine particles 21 and the binder 22. With this configuration, the bonding strength of the antireflection film 20 to the lens 11 is more likely to be enhanced. The bonding strength between the fine particles 21 and the binder 22 is enhanced, and the fine particles 21 are less likely to come off the antireflection film 20. As a result, the bonding strength of the antireflection film 20 to the lens 11 is more likely to be enhanced.

The average particle diameter of the fine particles 21 is not limited to a specific value. For example, the average particle diameter of the fine particles 21 is 80 to 600 nm. This makes it easier to adjust the size of the irregularities formed at the low-refractive-index portion 25a of the antireflection film 20 to the desired range, and makes it easier to improve the antireflective performance of the antireflection film 20. The average particle diameter of the fine particles 21 can be determined, for example, by observing a cross-section of the antireflection film 20 using a scanning electron microscope (SEM). Specifically, for randomly selected 50 particles that can be observed in their entirety, the maximum diameter of each particle and the minimum diameter of each particle are measured, the average of these values is taken as the particle diameter of each particle, and the average of the particle diameters of the 50 particles is taken as the “average particle diameter”. The average particle diameter of the fine particles 21 is preferably 100 nm to 500 nm, more preferably 100 nm to 300 nm, even more preferably 100 nm to 200 nm, and most preferably, more than 100 nm and not more than 150 nm.

The fine particles 21 are shaped, for example, as spherical particles. This makes it easier to form irregularities in the low-refractive-index portion 25a of the antireflection film 20 uniformly along the first plane 11a or the second plane 11b, and makes it easier to improve the antireflective performance of the antireflection film 20. In the present Description, the term “spherical” refers to a shape in which the ratio (DI/Ds) of the maximum diameter (DI) of the fine particles 21 to the minimum diameter (Ds) of the fine particles 21 is 1.5 or less in an observation of the fine particles 21 using a scanning electron microscope (SEM).

In a plan view of the antireflection film 20, the fine particles 21 are disposed to cover entirely the first plane 11a or the second plane 11b, for example. In the antireflection film 20, the fine particles 21 are disposed to form a monolayer. For example, in a pair of neighboring fine particles 21, in the case where the center of one of the fine particles is located closer to the first plane 11a or to the second plane 11b than the outermost part of the other fine particle 21 in the thickness direction of the antireflection film 20, then the fine particles 21 may be regarded as forming a monolayer. Alternatively, the fine particles 21 may be disposed to form a multilayer. In a pair of neighboring fine particles 21, in the case where the center of one of the fine particles is located closer to the outermost part of the antireflection film 20 than the outermost part of the other fine particle 21 in the thickness direction of the antireflection film 20, then the fine particles 21 may be regarded as forming a multilayer.

The fine particles 21 are, for example, solid particles. In this case, the antireflection film 20 tends to have the desired mechanical strength. Since the antireflection film 20 may come into contact with other objects during maintenance of the above-mentioned apparatus, the high mechanical strength of the antireflection film 20 is advantageous from the viewpoint of suppressing degradation in the antireflective performance of the antireflection film 20 regardless of maintenance of the apparatus.

The content of the fine particles 21 in the antireflection film 20 is not limited to a specific value. The content is, for example, 35% to 90% by mass. In this case, the fine particles 21 are more likely to be disposed in the desired state in the antireflection film 20, and the antireflective performance of the antireflection film 20 is more likely to be improved. The content of the fine particles 21 in the antireflection film 20 is preferably 40% to 90%, and more preferably 45% to 85%.

The thickness of the antireflection film 20 is not limited to a specific value. For example, the thickness of the antireflection film 20 is 80 nm to 800 nm. In this case, the antireflective performance of the antireflection film 20 is likely to be improved. The thickness of the antireflection film 20 is preferably 100 nm to 500 nm, and more preferably, it is more than 100 nm and not more than 150 nm. The thickness of the antireflection film 20 can be determined, for example, as the product of the average value of the distance from the first plane 11a or the second plane 11b in the thickness direction of the antireflection film 20 to the outermost part of a convexity of the irregularities on the surface layer of the antireflection film 20 and the filling rate of the fine particles 21 per unit distance. The unit distance is, for example, a distance corresponding to an integer multiple (for example, 10 times) of the average particle diameter of the fine particles 21. The filling rate is the number of convexities contained in the unit distance divided by the integer multiple of the average particle diameter of the fine particles 21 corresponding to the unit distance. The thickness of the antireflection film 20 can be determined by observing a cross-section of the antireflection film 20 using SEM.

The ratio of the average particle diameter of the fine particles 21 to the thickness of the antireflection film 20 is not limited to a specific value. The ratio is, for example, in a range of 0.3 to 1, preferably in a range of 0.5 to 1, and more preferably in a range of 0.8 to 1.

The thickness of the base portion 25b in the antireflection film 20 is not limited to a specific value. The thickness of the base portion 25b is, for example, an arithmetic average of the thicknesses of the base portion 25b at the point where the thickness of the antireflection film 20 described above is determined. The thickness of the base portion 25b is, for example, 10 nm to 300 nm, preferably 10 nm to 200 nm, and more preferably 10 nm to 70 nm.

The thickness of the low-refractive-index portion 25a of the antireflection film 20 is not limited to a specific value. The thickness of the low-refractive-index portion 25a is determined, for example, by subtracting the thickness of the base portion 25b from the thickness of the antireflection film 20 determined as described above. The thickness of the low-refractive-index portion 25a is, for example, 30 nm to 600 nm, preferably 35 nm to 500 nm, more preferably 40 nm to 300 nm, and even more preferably 40 nm to 200 nm, and particularly preferably 40 nm to 130 nm.

A ratio of the thickness of the low-refractive-index portion 25a to the thickness of the base portion 25b is not limited to a specific value. This ratio is, for example, 1 to 8. With this configuration, the bonding strength of the antireflection film 20 to the lens 11 is more likely to be enhanced. This ratio is preferably in a range of 1 to 7, and more preferably in a range of 1 to 6.

The components contained in the binder 22 are not limited to specific components. The binder 22, for example, contains silica as a main component. The binder 22 may contain silica alone, it may contain a hydrophobic group, or it may contain an aluminum compound.

The content of the binder in the antireflection film 20 is not limited to a specific value. The content is, for example, 5% to 64% by mass. In this case, the irregularities on the surface layer of the antireflection film 20 is likely to be formed in a desired state, and the antireflective performance of the antireflection film 20 is likely to be improved. In addition, the base portion 25b is likely to be formed over the entire antireflection film 20, and the bonding strength of the antireflection film 20 to the lens 11 is more likely to be high. The content of the binder in the antireflection film 20 is preferably 10% to 60%, and more preferably 15% to 55%.

For example, in the case where the binder content in the antireflection film 20 is 5% to 35%, the antireflective performance of the antireflection film 20 is more likely to be improved. From the viewpoint of antireflective performance, this content is preferably 10% to 35%, and more preferably 15% to 35%.

In the case where the content of the binder in the antireflection film 20 is 35% to 64%, the bonding strength of the antireflection film 20 to the lens 11 is more likely to be high, and the antireflection film 20 is likely to have high durability. For example, the antireflection film 20 is likely to have high scratch resistance. From the viewpoint of scratch resistance, this content is preferably 35% to 60%, more preferably 35% to 50%, and even more preferably 35% to 40%. For example, the antireflection film 20 has a pencil hardness of HB or higher, which means the antireflection film 20 may remain when scratched with a pencil of HB or higher under specified conditions. This pencil hardness is preferably H or higher, and more preferably 2H or higher.

If the bonding strength of the antireflection film 20 to the lens 11 is high, the antireflection film 20 is likely to have excellent peeling resistance. As described above, the lens array 1a can be used in an apparatus for defect inspection by use of reflected light from the inspection object being conveyed. Such an apparatus may require a space for maintenance. In the lens array 1a, the working distance L₁ of the lenses is equal to or greater than a predetermined value. Even with this lens array 1a, it is not always possible to ensure a sufficient space for maintenance of the apparatus. For this reason, the fact that the antireflection film 20 provides the lens 11 with high scratch resistance or high peeling resistance is particularly advantageous when considering contact between the lens array and other objects during maintenance of the apparatus.

The silica contained in the binder 22 is derived, for example, from a hydrolysable silicon compound or a hydrolysate of a hydrolysable silicon compound where the hydrolysable silicon compound or the hydrolysate of a hydrolysable silicon compound is added to a coating solution for forming the antireflection film 20. This hydrolysable silicon compound includes, for example, a compound shown in the following Formula (Ia).

In the following Formula (Ia), X is at least one selected from the group consisting of an alkoxyl group, an acetoxy group, an alkenyloxy group, an amino group, and a halogen atom. In the present Description, the hydrolysable silicon compound includes an oligomer of the hydrolysable silicon compound. This oligomer is formed by condensing about 2 to 200 molecules of the same type, for example.

SiX₄ (Ia)

The source of silica contained in the binder 22 can be a hydrolysable silicon compound, such as silicon alkoxide. Examples of silicon alkoxide include tetramethoxysilane, tetraethoxysilane, and tetraisopropoxysilane. These hydrolysable silicon compounds are hydrolyzed and polycondensed using the so-called sol-gel method to form the binder 22.

Though the hydrolysis of the hydrolysable silicon compound can be carried out as appropriate, preferably it is carried out in a solution containing the fine particles 21. The reason is as follows. That is, the polycondensation reaction between the silanol groups on the surface of the fine particles 21 and the silanol groups generated by the hydrolysis of the hydrolysable silicon compound, such as silicon alkoxide, is promoted, and the proportion of the binder 22 that contributes to the improvement of the bonding force of the fine particles 21 is enhanced. It is preferable to prepare the coating solution by adding the hydrolysis catalyst and the silicon alkoxide sequentially while stirring the solution containing the fine particles 21. The silicon alkoxide may be a monomer or an oligomer. Though either an acid or a base may be used as the hydrolysis catalyst, use of an acid, especially an acid with a high degree of ionization in aqueous solution, is preferable. Specifically, it is preferable to use an acid with an acid dissociation constant pKa (this means the first acid dissociation constant in the case where the acid is a polybasic acid) of 2.5 or less. Examples of suitable acids include volatile inorganic acids such as a hydrochloric acid and a nitric acid, organic acids such as a trifluoroacetic acid, a methanesulfonic acid, a benzenesulfonic acid, and a p-toluene sulfonic acid, and polybasic acids such as a maleic acid, a phosphoric acid, and an oxalic acid. Acidic substances are more effective than basic substances since acidity imparts preferable dispersion of the silica fine particles and excellent stability of the coating solution. Furthermore, a chlorine ion derived from a hydrochloric acid increases the concentration of chlorine ion in the coating solution, and in the case where aluminum chloride is added to the coating solution, the effect of aluminum chloride can be further promoted.

In the case where the binder 22 includes a hydrophobic group, the content of the hydrophobic group in the antireflection film 20 is not limited to a specific value. The content of the hydrophobic group is, for example, 0 to 10% by mass. With this configuration, dirt on the antireflection film 20 is easily removed. The content of the hydrophobic group contained in the binder 22 in the antireflection film 20 is preferably 0.2% to 10%, and more preferably 0.2% to 8%.

The hydrophobic groups contained in the binder 22 are preferably derived from a hydrolysable silicon compound or a hydrolysate of a hydrolysable silicon compound added to the coating solution for forming the antireflection film 20, where the hydrolysable silicon compound or the hydrolysate of the hydrolysable silicon compound has a hydrophobic group directly bonded to silicon. This hydrolysable silicon compound includes, for example, a compound shown in the following Formula (11a). In the following Formula (11a), Y as a hydrolysable group is preferably at least one selected from the group consisting of an alkoxyl group, an acetoxy group, an alkenyloxy group, an amino group, and a halogen atom. In the following Formula (11a), R as a hydrophobic group is preferably a linear or cyclic alkyl group with a carbon number of 1 to 30, at least a part of the hydrogen atom of which may be substituted by a fluorine atom, more preferably a linear alkyl group, further preferably a linear alkyl group with a carbon number of 1 to 3, and most preferably a methyl group.

RSiY₃ (IIa)

In the case where the binder 22 includes an aluminum compound, the content of the aluminum compound in the antireflection film 20 is not limited to a specific value. The content is, for example, 0 to 7% by mass when calculated as Al₂O₃. With this configuration, the antireflection film 20 tends to have a high chemical durability. Therefore, the antireflection film 20 tends to have the desired chemical resistance, in particular, the desired alkali resistance. As a result, the types of objects that can be inspected using the lens array 1a is likely to be increased. The content of aluminum compound in the antireflection film 20 is preferably 2 to 7%, and more preferably 4 to 7%.

As shown in FIG. 4, an apparatus 2a including a lens array 1a can be provided. The apparatus 2a is an apparatus for defect inspection by use of reflected light from an inspection object T being conveyed. The apparatus 2a includes a reader 71, an illuminator 72, a controller 73, an output device 74, a conveyor 75, and a conveyance-control device 76. A lens array 1a is disposed inside the reader 71. The conveyor 75 is, for example, a belt conveyor. The conveyor 75 may be a conveyor corresponding to a roll-to-roll method. The conveyor 75 conveys the inspection object T, such as a printed circuit board, a textile, a film, or paper. The conveyance-control device 76 is a digital computer for controlling the conveyor 75, and it outputs control signals to the conveyor 75 for adjusting the conveyance speed of the conveyor 75. The reader 71 and the illuminator 72 are disposed above the conveyor 75, for example, and the inspection object T is conveyed to pass directly below the reader 71 by the conveyor 75. The reader 71 and the illuminator 72 are disposed such that the reflected light is focused on the lens array 1a, where the reflected light is generated when the light emitted from the illuminator 72 is reflected by the inspection object T. This enables the reader 71 to obtain image data of the inspection object T. The controller 73 is a digital computer to form the image data of the inspection object T. When the inspection object T passes directly below the reader 71, the controller 73 continuously acquires image information from the reader 71. In addition, the controller 73 acquires conveyance position information of the inspection object T from the reader 71. The controller 73 performs calculation processing based on the image information acquired from the reader 71 and the conveyance position information acquired from the conveyance-control device 76, thereby forming two-dimensional image information. The thus formed two-dimensional image information is compared with information that characterizes defects such as foreign matters, cracks, and pinholes, where the information is stored in advance in the controller 73. Thereby, the controller 73 identifies the presence or absence of defects in the inspection object T, the number of the defects, and the position of the defects. The controller 73 may determine whether the inspection object T is favorable or not based on the comparison results. The output device 74 is, for example, a monitor, which displays the two-dimensional image information formed by the controller 73.

### EXAMPLES

The present invention will be explained in more detail with reference to Examples. The present invention is not limited to the following Examples.

### Reference Example 1

Raw materials of glass were mixed to make the composition shown in Table 1, and the mixture was melted to obtain molten glass (glass composition) according to Reference Example 1. The numerical values in Table 1 indicate mol %. The molten glass according to Reference Example 1 was spun to form a fiber, and the resulting glass fiber was cut to a predetermined length and the cross section was polished. In this way, a glass strand according to Reference Example 1 was obtained. The diameter (wire diameter) of the glass strand was 1000 μm. Next, the glass strand was immersed in molten sodium nitrate heated to a temperature close to the glass transition temperature of the glass composition that constitutes each glass strand, and an ion exchange treatment was performed. In this way, a refractive index distribution in each glass strand was formed. After that, the glass strand subjected to the ion exchange treatment were cut to the specified length to obtain the lens according to Reference Example 1. Table 2 shows a working distance L₁, a lens length Z, a conjugation length TC, a visual field radius X₀, an aperture angle θc, a refractive index distribution constant g [mm⁻¹], and a refractive index n₀ at the central axis of the lens.

Between a pair of rectangular FRP plates disposed parallel to each other, a plurality of lenses according to Reference Example 1 were disposed in two rows adjacent along the longitudinal direction of the plate at intervals of 1 mm so as to be parallel to each other. In this state, the lenses were fixed by filling the space between the plates with a black-colored adhesive resin and curing the resin. In this state, the both ends of each lens were cut off and the end faces were polished. Meanwhile, another pair of FRP substrates were disposed at both ends of the flat plate in the longitudinal direction, and the lenses and the adhesive portion obtained by curing the adhesive resin were contained in a frame formed with these FRP flat plates. In this way, a lens array according to Reference Example 1 was obtained.

### Example 1

28.3 parts by mass of silica fine particle dispersion (Quartron PL-7, substantially spherical primary particles with an average particle diameter of 125 nm, solid content concentration of 23 weight %, manufactured by FUSO CHEMICAL CO., LTD.), 58.6 parts by mass of 1-methoxy-2-propanol (solvent), and 1 part by mass of 1N hydrochloric acid (hydrolysis catalyst) were mixed while stirring. While further stirring the mixture, 12.1 parts by mass of tetraethoxysilane (ethyl orthosilicate, manufactured by Tama Chemical Co., Ltd.) was added thereto, and the mixture was further stirred for 8 hours while being kept at 40 °C to hydrolyze the tetraethoxysilane, whereby an undiluted solution A was obtained. In the undiluted solution A, a ratio of a mass of the silica fine particles to a mass of the hydrolytic condensation product of the hydrolysable silicon compound contained in the binder was 65:35.

16.0 g of the above-mentioned undiluted solution A, 5.0 g of propylene glycol (solvent), 78.5 g of 1-methoxy-2-propanol (solvent), 0.4 g of aluminum chloride aqueous solution (concentration of 47.6 mass % in terms of AlCl₃, prepared by dissolving reagent-grade aluminum chloride hexahydrate (manufactured by Sigma-Aldrich Co., Ltd.) in deionized water), 0.1 g of KP-112 (polyether-type surface modifier, 50 mass % concentration 1-methoxy-2-propanol solution, manufactured by Shin-Etsu Chemical Co., Ltd.) were mixed while stirring, whereby a coating solution according to Example 1 was obtained. In this coating solution, the solid content concentration of silica (derived from silica fine particles and alkoxysilanes) calculated as SiO₂ was 1.6 mass %, and the aluminum compound calculated as Al₂O₃ was 5.0 parts by mass when the oxide of silicon calculated as SiO₂ was 100 parts by mass.

A lens array was produced similarly to Reference Example 1, and a coating solution according to Example 1 was applied by dip coating onto the both end faces in the longitudinal direction of the lens array, whereby a coating film was formed. In the dip coating, the lens array was fixed with a clip to a support of a dip coater, immersed in the coating solution according to Example 1, where the coating solution fills the container, and then the lens array was pulled up at a speed of 2.6 mm/sec. to form the coating film. This coating film was heated at 200 °C for 1800 seconds to form antireflection films on both end faces of the lens array in the longitudinal direction of the lens. In this way, a lens array according to Example 1 was obtained.

### Example 2

A coating solution according to Example 2 was obtained in the same way as Example 1, except that no aluminum chloride aqueous solution was added. A lens array according to Example 2 was obtained in the same way as Example 1, except that the coating solution according to Example 2 was used instead of the coating solution according to Example 1.

### Example 3

A coating solution according to Example 3 was prepared in the same way as Example 2, except that the amount of each raw material to be added was adjusted so that the content of each component would be as shown in Table 3. The concentration of the solid content in the coating solution according to Example 3 was 1.3 mass %. The lens array according to Example 3 was obtained in the same way as Example 1, except that the coating solution according to Example 3 was used instead of the coating solution according to Example 1, and the speed for pull-up in the dip coating was adjusted to 2.0 mm/sec.

### Example 4

A coating solution according to Example 4 was prepared in the same way as Example 1, except that methyl triethoxysilane (manufactured by Shin-Etsu Chemical Co., Ltd.) was added together with the tetraethoxysilane, and the amount of each raw material added was adjusted so that the content of each component would be as shown in Table 3. Aluminum nitrate was used as the aluminum compound instead of the aluminum chloride. The concentration of solid content in the coating solution according to Example 4 was 1.6 mass %. The content of the methyl group as a hydrophobic group in the solid content of the coating solution was 2.8 mass %. A lens array according to Example 4 was obtained in the same way as Example 1, except that the coating solution according to Example 4 was used instead of the coating solution according to Example 1.

### Example 5

A coating solution according to Example 5 was prepared in the same way as Example 4, except that the methyl triethoxysilane was not added and the amount of each raw material was adjusted so that the content of each component would be as shown in Table 3. A lens array according to Example 5 was obtained in the same way as Example 1, except that the coating solution according to Example 5 was used instead of the coating solution according to Example 1.

### Example 6

A lens array according to Example 6 was obtained in the same way as Example 1, except for the following points. A coating solution according to Example 6 was prepared by adjusting the amount of each component so that the solid content concentration would be 2.5 mass %. In the dip coating, the coating solution according to Example 6 was used instead of the coating solution according to Example 1, and the pull-up speed in the dip coating was adjusted to 1.0 mm/sec.

### Example 7

A lens array according to Example 7 was obtained in the same way as Example 1, except for the following points. A coating solution according to Example 7 was prepared by adjusting the amount of each component so that the solid content concentration would be 3.5 mass %. In the dip coating, the coating solution according to Example 7 was used instead of the coating solution according to Example 1, and the pull-up speed in the dip coating was adjusted to 1.0 mm/sec.

### Example 8

0.6 g of tetraethoxysilane (TEOS) (manufactured by Tokyo Chemical Industry Co., Ltd.), 1.18 g of methyl triethoxysilane (MTES) (manufactured by Tokyo Chemical Industry Co., Ltd.), 0.82 g of 0.3 mass % formic acid (Kishida Chemical Co., Ltd.), 3 g of sol containing hollow silica particles (product name: Thrulya 4110, manufactured by JGC Catalysts and Chemicals, Ltd.), and 22.4 g of ethanol (manufactured by Kishida Chemical Co., Ltd.) were mixed and allowed to react at 35 °C for 3 hours. The sol containing hollow silica particles used contained a solvent and 25 mass % of hollow silica as a solid content, and the average particle diameter of the hollow silica particles in the particle size distribution based on the number of particles was approximately 50 nm. The thickness of the silica shell of the hollow silica particles was 10 to 20 nm. The maximum dimension of the internal space of the hollow silica particles was approximately 10 to 30 nm. The refractive index of the hollow particles was 1.25. In this way, the coating solution according to Example 8 was obtained. In the coating solution according to Example 8, the content of solid matter derived from TEOS was 0.6 mass % when calculated as silica, the content of methylsilsesquioxane (MeSq) as a solid matter derived from MTES was 1.6 mass %, and the content of hollow silica particles was 2.6 mass %. In the solid content of the coating solution according to Example 8, 13% of silica derived from TEOS, 33% of MeSq derived from MTES, and 54% of hollow silica particles were contained by mass. The content of hollow silica particles was calculated based on the assumption that the solid content of the hollow silica particle-containing sol was 25 mass %, and that the solid content was hollow silica particles. A molar ratio of an amount of the MTES to an amount of the TEOS added in the preparation of the coating solution according to Example 8 was 7/3. A lens array according to Example 8 was obtained in the same way as Example 2, except that the coating solution according to Example 8 was used instead of the coating solution according to Example 2. FIG. 6 is a cross-sectional view showing schematically an antireflection film in the lens array of Example 8. As shown in FIG. 6, an antireflection film 20 is disposed in contact with an end face in the longitudinal direction of the lens 11. The antireflection film 20 includes hollow silica particles 53 and a binder 54, and voids 55 are present in the interior of the antireflection film 20 and at the boundary between the antireflection film 20 and the end face of the lens 11.

### (Light Intensity Measurement)

A flat reflector was placed on an object plane corresponding to a working distance of a lens of the lens array of each Example, the reflected light from the light source was incident on the lens array, so that the light intensity [Ix] at the position corresponding to the image plane of the lens array was measured. The relative values of the light intensity in the case of using the lens arrays of Examples 1 to 7 at a wavelength of 530 nm were calculated, where the light intensity for the case of using the lens array of Reference Example 1 at a wavelength of 530 nm was set to 100. The results are shown in Table 4. The lens arrays according to Examples 1, 3, 4, 6, and 7 were evaluated in the same way after the end faces of the lens arrays were rubbed 40 times with Toraysee (registered trademark), a cloth manufactured by Toray Industries, Inc. Here, a dry cloth was used. For the lens arrays according to Examples 1, 3, 4, 6, and 7, the end faces of the lens arrays were rubbed 40 times with a fabric soaked in ethanol, and then evaluated in the same way as for the light intensity. The results are shown in Table 4.

### (Pencil Hardness)

A pencil hardness tester (Pencil Scratch Hardness Tester Model: 720N, Brand: Sheen Instruments-UK) and pencils (UNI, hardness 2B to 9H, manufactured by MITSUBISHI PENCIL COMPANY LIMITED) were used to carry out a pencil hardness test on the antireflection films formed on the lens arrays of Examples 1 to 8, in accordance with the Japanese Industrial Standards (JIS) K 5600 May 4. In this test, the angle of the pencil to the antireflection film was 45°, and the pencil was pressed down with a load of 750 g. The pencil hardness was measured by pressing and moving the pencil lead with several levels of hardness against the antireflection film, gradually increasing the hardness. In this measurement, the speed at which the pencil was moved was 1 mm/see, and the distance the pencil was moved was adjusted to 20 mm or more. After the test, the pencil lead dust on the antireflection film was wiped off with BEMCOT soaked in ethanol, and the scratches caused by the test on the antireflection film were observed with an optical microscope. The pencil hardness of the antireflective film was evaluated as a hardness one level lower than the hardness at the time a scratch occurs to damage the antireflection film or at the time the antireflection film is peeled to expose a substrate surface, i.e., the maximum hardness at which the antireflective film was not scratched or at which peeling to expose the substrate surface did not occur. The results are shown in Table 4.

### (SEM Observation)

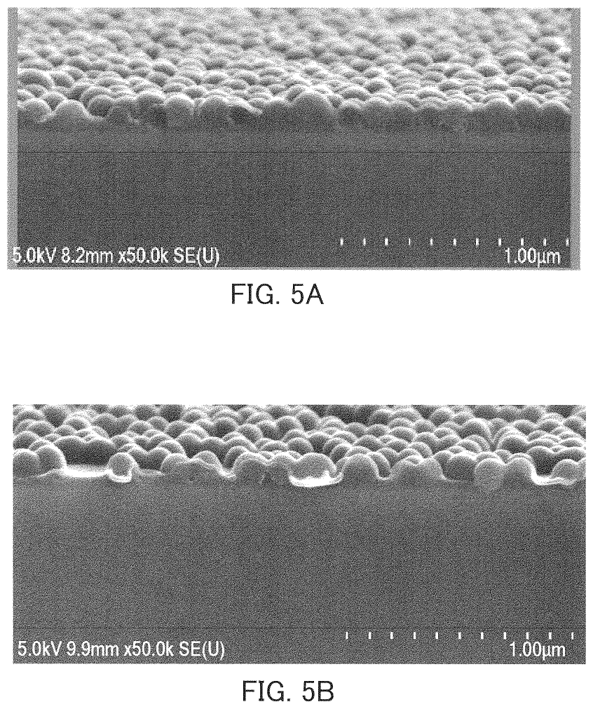

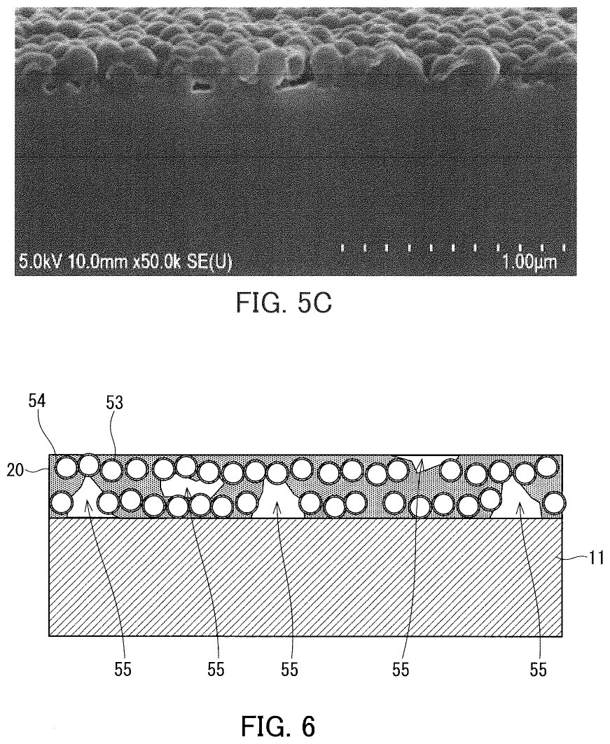

The cross-sections of the antireflection films formed on the lens arrays according to Examples 1 to 7 were observed using a field emission scanning electron microscope (FE-SEM) (model: S-4500 manufactured by Hitachi, Ltd.). In the FE-SEM photograph of the cross-section of each antireflection film taken at an angle of 10° above the surface, a distance in the thickness direction of the antireflection film between the outermost part of each convexity of the surface irregularities of the antireflection film appearing at a distance (1250 nm) equivalent to 10 times the average particle diameter of the silica fine particles and the end face of the lens array being in contact with the antireflection film was measured, and an arithmetic mean D1 of the distance was obtained. Furthermore, the number of convexities appearing at the position was identified. The number was divided by 10 to determine the silica fine particle filling rate f per unit distance. A thickness T1 of the antireflection film was determined as the product of the arithmetic mean D1 and the filling rate f. The results are shown in Table 4. In addition, an arithmetic mean T2 of the base portion thickness at a part of the antireflection film used to determine the arithmetic mean D1 was determined. A thickness T3 of the low-refractive-index portion was determined by subtracting the arithmetic mean T2 of the base portion thickness from the thickness T1 of the antireflection film. The results are shown in Table 4. FE-SEM photographs of the cross-sections of the antireflection films formed on the lens arrays of Examples 1, 6, and 7 are shown in FIG. 5A, FIG. 5B, and FIG. 5C, respectively.

### (Reflectance Measurement A)

Reflectance of one end face of a lens in each of the lens arrays according to Reference Example 1 and Examples 1 to 7 was measured using a near-infrared micro-spectrophotometer USPM-RU-W manufactured by OLYMPUS CORPORATION. In this measurement, the wavelength range was set to 380 to 1050 nm, and the diameter of the measurement range was adjusted to 70 μm using an objective lens having a magnification of 10 times. In addition, the position for measuring reflectance was adjusted to the central position of the lens in the lens array. The results are shown in Table 4.

### (Reflectance Measurement B)

An antireflection film was formed on the surface of a glass sheet in the same way as in Examples 1 and 3, except that a float glass substrate was used instead of the lens array. In addition, an optical interference film, which is a dielectric multilayer film, was formed on the surface of the float glass substrate by physical vapor deposition (PVD) to obtain an antireflection film according to Comparative Example 1. The reflectance of these antireflection films formed on the surface of the glass sheets was measured using a near-infrared micro-spectrophotometer USPM-RU-W manufactured by OLYMPUS CORPORATION. In addition, the reflectance of the surface of the glass sheet without the antireflection film was also measured in the same way. In this measurement, the wavelength range was set to 380 to 1050 nm, and the diameter of the measurement range was adjusted to 70 μm using an objective lens with a magnification of 10 times. The results are shown in Table 5.

### (Salt Spray Test)

A salt spray test was carried out in which salt water was sprayed onto the end faces of the lens arrays according to Examples 1 to 5 in the longitudinal direction of the lens, with reference to JIS C8917: 2005. In this salt spray test, the environmental temperature of the lens array was adjusted to 35 °C, and a 5 mass % sodium chloride aqueous solution was used as the salt water. The salt spray was performed for 96 hours. The change in the transmittance of the lens array before and after the salt spray test was measured. For this measurement, light in the wavelength range of 380 to 850 nm was used, and the change in the average transmittance in this range was determined. The results are shown in Table 5.

Since the working distance L₁ of the lenses of the lens array according to each Example is 5 mm or more, a space sufficient for maintenance of the apparatus can be secured even in a case where the apparatus is used for defect inspection by use of reflected light from the inspection object being conveyed.

As shown in Table 4, a comparison of the lens array according to Reference Example 1 and the lens arrays according to Examples 1 to 8 shows that the intensity of light passing through a lens array can be increased by forming an antireflection film on the end faces of the lenses of the lens array. For this reason, formation of an antireflection film is regarded as advantageous from the viewpoint of suppressing the decrease in the light intensity, which is caused by the large working distance L₁. In addition, it is understood that even if the antireflection film of the lens array according to any of Example 1, 3, 4, 6, or 7 is rubbed with a specified fabric, the intensity of light passing through the lens array is maintained at a high level. According to the results of reflectance measurement A, it is understood that the antireflection films of the lens arrays according to Examples 1 to 7 reduce the reflectance of the end face in the longitudinal direction of the lens compared to the lens array according to Reference Example 1.

In particular, it is understood that the antireflection film according to Example 3 is capable of exhibiting high antireflective performance and increasing the intensity of light passing through the lens array.

Example 4 suggests that the antireflection film has high scratch resistance, while the antireflection film exhibits the specified antireflective performance and has high pencil hardness.

As shown in Table 5, the antireflection films formed using the coating solutions according to Examples 1 and 3 can reduce reflectance at wavelengths of 530 nm, 700 nm, 900 nm, and 1000 nm, compared to a glass sheet without such an antireflection film. Furthermore, unlike the antireflection film of Comparative Example 1, these antireflection films can prevent reflectance from increasing rapidly with increasing wavelength, and as a result, it is understood that the antireflection films can exhibit antireflective properties even at wavelengths in the near-infrared region.

As shown in Table 4, a comparison between Example 1 and Example 2 shows that the amount of change in transmittance before and after the salt spray test is small in Example 1, and it is understood that the antireflection film of the lens array according to Example 1 has higher chemical resistance, particularly higher alkali resistance, than the antireflection film of the lens array according to Example 2. It is understood that the inclusion of aluminum compound in the binder of the antireflection film is advantageous from the viewpoint of enhancing chemical resistance, particularly alkali resistance. A comparison between Example 4 and Example 5 shows that the amount of change in transmittance before and after the salt spray test is small in Example 4, and it is understood that the antireflection film of the lens array according to Example 4 has higher chemical resistance, particularly higher alkali resistance, than the antireflection film of the lens array according to Example 5. It is understood that the inclusion of a hydrophobic group such as a methyl group in the binder of the antireflection film is advantageous from the viewpoint of enhancing chemical resistance, particularly alkali resistance.

As shown in FIG. 5A to FIG. 5C, the surface layers of the antireflection films formed on the lens arrays according to Examples 1, 6, and 7 had low-refractive-index portions with irregularities, in which silica fine particles were disposed to form a monolayer or a multilayer. Taking the refractive index of silica into consideration, it is understood that the refractive index of the low-refractive-index portion is lower than the refractive index no at the central axis line of the lens of the lens array. In addition, a base portion was formed between the irregularities of the surface layer and the lens array, and the binder formed a phase at the base portion. The base portion of the antireflection film contains a large amount of binder, and the binder content at the base portion is considered to be higher than the binder content at the low-refractive-index portion by mass.

TABLE 1

| | Reference Example 1 |
|---|---|
| SiO₂ | 53 |
| TiO₂ | 3.5 |
| B₂O₃ | 3 |
| MgO | 1 |
| ZnO | 9 |
| SrO | 6 |
| BaO | 6 |
| Li₂O | 9.5 |
| Na₂O | 9 |
| K₂O | 0 |
| Cs₂O | 0 |
| ZrO₂ | 0 |
| Sb₂O₃ | 0 |

TABLE 2

| | Reference Example 1 |
|---|---|
| Working distance L₁ [mm] | 18.1 |
| Lens length Z [mm] | 17.8 |
| Conjugation length TC [mm] | 54.0 |
| Visual field radius X₀ [mm] | 2.9 |
| Aperture angle θ_{C} [°] | 9.0 |
| Refractive index distribution constant g [mm⁻¹] | 0.1964 |
| Central refractive index n₀ [—] | 1.60 |

TABLE 3

| | | | | Example | Example | Example | Example | Example |
|---|---|---|---|---|---|---|---|---|
| | | | | 1 | 3 | 4 | 5 | 8 |
| Anti- | Silica fine particles [mass %] | | | 61.9 | 85.0 | 52.4 | 52.4 | 54 |
| reflection | Binder | Silica [mass %] | | 33.3 | 15.0 | 42.9 | 42.9 | 38.6 |
| film | | Hydro- | Type | — | — | Methyl | — | Methyl |
| | | phobic | | | | group | | group |
| | | group | Content | 0 | 0 | 2.8 | 0 | 7.4 |
| | | | [mass %] | | | | | |

| | | | | | |
|---|---|---|---|---|---|
| Aluminum compound | 4.8 | — | 4.8 | 4.8 | — |
| (in terms of Al₂O₃) | | | | | |
| [mass %] | | | | | |

| | | | | | | |
|---|---|---|---|---|---|---|
| Mass ratio | Silica fine particles [mass ratio] | 65.0 | 85.0 | 55.0 | 55.0 | 54 |
| | Binder [mass ratio] | 35.0 | 15.0 | 45.0 | 45.0 | 46 |

| | | | | | |
|---|---|---|---|---|---|
| Type of aluminum compound | AlCl₃ | — | Al(NO₃)₃ | Al(NO₃)₃ | — |
| Aluminum compound converted to metal oxide | 5 | 0 | 5 | 5 | 0 |
| (Al₂O₃) when silica component converted to | | | | | |
| SiO₂ is taken as 100 parts by mass [part by | | | | | |
| mass] | | | | | |

TABLE 4

| | | Example | Example | Example | Example | Example |
|---|---|---|---|---|---|---|
| | | 1 | 2 | 3 | 4 | 5 |
| Film thickness T1 [nm] | | 128 | 128 | 125 | 127 | 127 |
| Low-refractive-index portion thickness T3 [nm] | | 83 | 83 | 105 | 70 | 70 |
| Base portion thickness T2 [nm] | | 45 | 45 | 20 | 57 | 57 |
| Relative | No rubbing | 105 | 105 | 108 | 105 | 105 |
| value of light | After rubbing 40 times with | 105 | — | 108 | 105 | — |
| intensity at | Traysee | | | | | |
| wavelength | After rubbing 40 times with | 105 | — | 108 | 105 | — |
| of 530 nm | fabric soaked in ethanol | | | | | |
| [%] | | | | | | |
| Pencil hardness | | H | H | HB | 3H | 3H |
| Reflectance | Minimum reflectance [%] | 0.8 | 0.9 | 0.3 | 1.0 | 1.0 |
| Measurement | Wavelength corresponding to | 628 | 630 | 635 | 630 | 630 |
| A | minimum reflectance [nm] | | | | | |
| | Reflectance at wavelength of | 1.1 | 1.2 | 1.1 | 1.3 | 1.3 |
| | 530 nm [%] | | | | | |
| | Reflectance at wavelength of | 1.1 | 1.1 | 0.7 | 1.0 | 1.0 |
| | 700 nm [%] | | | | | |
| | Reflectance at wavelength of | 1.5 | 1.5 | 0.9 | 1.4 | 1.3 |
| | 900 nm [%] | | | | | |
| | Reflectance at wavelength of | 1.8 | 1.8 | 1.1 | 1.8 | 1.8 |
| | 1000 nm [%] | | | | | |

| | | | | | |
|---|---|---|---|---|---|
| Amount of change in transmittance before and | 0.06 | 0.30 | — | 0.14 | 0.27 |
| after salt spray test [%] | | | | | |

TABLE 4
Continued

| | | | | | Reference |
|---|---|---|---|---|---|
| | | Example 6 | Example 7 | Example 8 | Example 1 |
| Film thickness T1 [nm] | | 101 | 161 | 120 | |
| Low-refractive-index portion thickness T3 [nm] | | 56 | 116 | — | |
| Base portion thickness T2 [nm] | | 45 | 45 | — | |
| Relative | No rubbing | 106 | 104 | 109 | |
| value of light | After rubbing 40 times with | 106 | 104 | — | |
| intensity at | Traysee | | | | |
| wavelength | After rubbing 40 times with | 106 | 104 | — | |
| of 530 nm [%] | fabric soaked in ethanol | | | | |
| Pencil hardness | | H | HB | 2B | — |
| Reflectance | Minimum reflectance [%] | 0.6 | 0.8 | — | 4.9 |
| Measurement | Wavelength corresponding to | 460 | 685 | — | — |
| A | minimum reflectance [nm] | | | | |
| | Reflectance at wavelength of | 0.8 | 1.4 | — | 5.1 |
| | 530 nm [%] | | | | |
| | Reflectance at wavelength of | 1.7 | 0.8 | — | 5.0 |
| | 700 nm [%] | | | | |
| | Reflectance at wavelength of | 2.6 | 1.2 | — | 5.0 |
| | 900 nm [%] | | | | |
| | Reflectance at wavelength of | 2.9 | 1.5 | — | 5.0 |
| | 1000 nm [%] | | | | |

| | | | | |
|---|---|---|---|---|
| Amount of change in transmittance before and | — | — | — | — |
| after salt spray test [%] | | | | |

TABLE 5

| | | Exam- | Exam- | Comparative | Glass |
|---|---|---|---|---|---|
| | | ple 1 | ple 3 | Example 1 | sheet |
| Reflectance | Reflectance at | 1.14 | 0.28 | 0.59 | 3.99 |
| measurement | wavelength of | | | | |
| B | 530 nm [%] | | | | |
| | Reflectance at | 1.76 | 1.03 | 0.11 | 3.65 |
| | wavelength of | | | | |
| | 700 nm [%] | | | | |
| | Reflectance at | 2.15 | 1.63 | 4.71 | 3.23 |
| | wavelength of | | | | |
| | 900 nm [%] | | | | |
| | Reflectance at | 2.39 | 1.97 | 8.32 | 3.34 |
| | wavelength of | | | | |
| | 1000 nm [%] | | | | |

1. A lens array to be used for an apparatus for defect inspection by use of reflected light from an inspection object being conveyed, the lens array comprising:
a plurality of lenses for focusing the reflected light, the lenses being arrayed in a first direction that is a conveyance direction in which the inspection object is conveyed and a second direction perpendicular to the conveyance direction;
an adhesive portion for fixing the lenses together;
a housing containing the lenses and the adhesive portion; and
an antireflection film, wherein
the antireflection film includes fine particles and a binder, the fine particles having a refractive index equal to or less than a refractive index of the lenses, and the antireflection film is disposed in contact with at least one selected from the group consisting of a first plane of each of the lenses on which the reflected light is to be incident and a second plane of the lens from which the light incident on the first plane is to be emitted, and
the binder binds the fine particles to either the first plane or the second plane.

2. The lens array according to claim 1, wherein
the lenses are gradient index lenses.

3. The lens array according to claim 1, wherein
the antireflection film includes a surface layer having irregularities formed by the fine particles.

4. The lens array according to claim 3, wherein
the antireflection film includes a base portion between the irregularities and the lenses in a thickness direction of the antireflection film, and
the binder forms a layer to fill a space between the fine particles at the base portion.

5. The lens array according to claim 1, wherein
a bond involving a silicon atom is formed between the antireflection film and the lenses.

6. The lens array according to claim 1, wherein
the fine particles include silica as a main component.

7. The lens array according to claim 6, wherein
a bond involving a silicon atom is formed between the fine particles and the binder.

8. The lens array according to claim 1, wherein
the fine particles have an average particle diameter of 80 to 600 nm.

9. The lens array according to claim 1, wherein
the antireflection film has a thickness of 80 to 800 nm.

10. The lens array according to claim 1, wherein
a content of the binder in the antireflection film is 5 to 64 mass %, and
a content of the fine particles in the antireflection film is 35 to 90 mass %.

11. The lens array according to claim 1, wherein
the binder includes a hydrophobic group.

12. The lens array according to claim 11, wherein
a content of the hydrophobic group in the binder is 10 mass % or less.

13. The lens array according to claim 1, wherein
the binder includes an aluminum compound.

14. The lens array according to claim 13, wherein
a content of the aluminum compound in the antireflection film is 7 mass % or less when the content is calculated as Al₂O₃.

15. The lens array according to claim 1, wherein
the lenses each have a working distance of 15 mm or more.

16. The lens array according to claim 1, wherein
the lenses each have a central portion including, in mol %:
40%≤SiO₂≤65%;
0%≤TiO₂≤10%;
0.1%≤MgO≤22%;
0.15%≤ZnO≤15%;
0.5%≤Li₂O≤15%;
2%≤Na₂O≤20%;
0%≤B₂O₃≤20%;
0%≤Al₂O₃≤10%;
0%≤K₂O≤3%;
0%≤Cs₂O≤3%;
0%≤Y₂O₃≤5%;
0%≤ZrO₂≤2%;
0%≤Nb₂O₅≤5%;
0%≤In₂O₃≤5%;
0%≤La₂O₃≤5%; and
0%≤Ta₂O₅≤5%.

17. The lens array according to claim 1, wherein
the lenses form a plurality of rows adjacent in the second direction.
